(19) United States
(12) Patent Application Publication
(10) Pub. No.: US 2026/0219389 A1
(43) Pub. Date: Jul. 30, 2026

(54) METHOD FOR PROCESSING SENSOR DATA, METHOD FOR PROCESSING OUTPUT DATA, AND SIGNAL PROCESSING UNIT

(71) Applicant: Robert Bosch GmbH, Stuttgart (DE)

(72) Inventors: Robert Maiwald, Ludwigsburg (DE); Hermann Buddendick, Sindelfingen (DE); Jingyuan Qu, Korntal-Muenchingen (DE)

(21) Appl. No.: 19/152,094

(22) PCT Filed: Feb. 16, 2024
(86) PCT No.: PCT/EP2024/054004

§ 371 Date: Jul. 30, 2025

(30) Foreign Application Priority Data
Apr. 24, 2023 (DE) 10 2023 203 733.5

(51) Int. Cl. G01S 13/931

(52) U.S. Cl. CPC G01S 13/931

(57) ABSTRACT

A method for processing sensor data of a radar sensor which detects object targets in the surrounding area of a vehicle. The method includes: carrying out a signal processing of the sensor data and providing processing data which are obtained by the signal processing and which may be represented in at least one signal spectrum, detecting at least one peak which corresponds to one of the object targets in the signal spectrum; carrying out an information processing of the processing data assigned to the peak; and outputting output data which are generated from the information processing and which contain at least the peak position of the detected peak in the signal spectrum, wherein the output data have additional output data which includes at least one peak parameter of the peak in addition to the peak position.

### FIELD

The present invention relates to a method for processing sensor data. The present invention additionally relates to a method for processing the output data and to a signal processing unit.

### BACKGROUND INFORMATION

In vehicles, radar sensors are preferably used to detect object targets in the surrounding area of a vehicle. Such radar sensors are designed, in particular as frequency modulated continuous wave radars (FMCW radars), as these are inexpensive and have a high resolution. An FMCW radar transmits a finite sequence of separate linear frequency modulated chirps in each coherent processing interval. At a receiver, the object target echoes are mixed with the transmitted signal, resulting in a complex beat signal or intermediate frequency signal. The distance information and velocity information of the object targets may be obtained from the frequencies of the intermediate frequency signal. Fast Fourier transforms (FFT) are usually used for this purpose.

In order to also obtain angle information of the object targets, a plurality of transmitting and receiving antennas (MIMO radar) are used. Two-dimensional frequency estimation algorithms, in particular 2D FFT, are used to obtain the distance information, angle information (angle of arrival), and velocity information of the received target echo signals. This results in signal spectra in the respective domain (angle, distance, velocity).

Subsequent peak detection is used to identify peaks in the signal spectra.

### SUMMARY

According to an example embodiment of the present invention, a method is provided which allows object targets in a surrounding area of a vehicle to be identified and characterized more reliably, accurately and quickly. The output data may be enriched with additional information.

According to an example embodiment of the present invention, the method processes sensor data of at least one radar sensor which detects object targets in the surrounding area of a vehicle.

According to an example embodiment of the present invention, the method includes signal processing of the sensor data and providing processing data which are obtained by the signal processing and which are representable in at least one signal spectrum; detecting at least one peak which corresponds to one of the object targets in the signal spectrum; carrying out an information processing of the processing data assigned to the peak and outputting output data which are generated from the information processing and which contain at least the peak position of the detected peak in the signal spectrum; wherein the output data have additional output data which comprise at least one peak parameter of the peak in addition to the peak position.

The vehicle may be a motor vehicle, in particular a motor vehicle with at least three wheels, a two-wheeled vehicle, in particular a motorcycle or a bicycle. The vehicle may be a robot, for example, a robotic lawnmower.

The radar sensor may be an FMCW radar sensor. The radar sensor may be a MIMO radar sensor.

The object targets may be objects or living beings. The object targets may be stationary, in particular signs, buildings, trees or moving, in particular other vehicles.

The sensor data may be processed or unprocessed measurement data from the radar sensor. The sensor data may be filtered and thus processed.

According to an example embodiment of the present invention, the signal processing may use an FFT (Fast Fourier transform).

A peak is the technical term for a locally significant signal peak value of a signal value distribution.

The object targets detected by the radar sensor may appear as peaks in the signal spectrum. The signal spectrum may contain distance information, angle information and/or velocity information for the detected targets in at least one dimension. Another dimension of the signal spectrum may comprise a signal intensity.

The output data may contain distance information, angle information and/or velocity information, and preferably information on the reflectivity of the object target assigned to the peak.

In a preferred embodiment of the present invention, it is advantageous if, in the information processing, the peak is assumed to be an idealized peak corresponding to a predetermined shape and the additional output data have the peak parameter of the idealized peak that at least approximates the peak. The idealized peak may be formed by a Gaussian function.

A preferred embodiment of the present invention is advantageous in which the peak parameter is a half-width of the peak. The half-width refers to the width of the peak at half its height. It therefore indicates how wide a peak is at half its height.

If several peaks are superimposed in the signal spectrum, a suitable approximation may be made, for example, by the information processing ascertaining the half-width as a function of the peak progression in only one direction or in the direction of the next minimum in the processing data.

In a particular embodiment of the present invention, it is advantageous if the output data assigned to the peak comprise only the peak position and the peak parameter.

In a particular embodiment of the present invention, it is advantageous if the additional output data comprise a further peak parameter of the peak in addition to the peak parameter.

This allows the shape of the peak to be described more precisely using the additional output data.

A preferred embodiment of the present invention is advantageous in which the signal spectrum is two-dimensional, and the peak parameter characterizes the shape of the peak in the signal spectrum. The two-dimensional signal spectrum may represent signal values over the distance, the velocity or the angle, in particular the elevation angle or the azimuth angle.

A preferred embodiment of the present invention is advantageous in which the signal spectrum is three-dimensional and the peak parameter characterizes the shape of the peak in a first dimension of the signal spectrum, and the further peak parameter characterizes the shape of the peak in the second dimension of the signal spectrum. The peak parameter may specify a half-width of the peak in the first dimension. The additional peak parameter may specify a half-width of the peak in the second dimension.

The signal spectrum may also have more than three dimensions.

According to the present invention, a further method is provided. The object detection may detect the object targets The object classification may classify the object targets.

In a preferred embodiment of the present invention, it is provided that the object detection and/or object classification includes at least one machine learning process with input data formed by the output data including the additional output data. The machine learning process may involve the use of at least one neural network. The neural network may be trained through deep learning. The neural network may a plurality of several network layers.

The object detection and/or object classification may be carried out by at least one object model comprising the neural network with the output data as input data.

The additional output data may be used as input data when inferring the object model. The additional output data may be used to evaluate the object model.

According to an example embodiment of the present invention, a signal processing unit is further proposed. The signal processing unit may be a data processing unit, in particular a computer. The signal processing unit may be connected to the radar sensor for data transmission. The signal processing unit may be located in the vehicle.

Further advantages and advantageous embodiments of the present invention are evident from the description of the figures and the figures.

### BRIEF DESCRIPTION OF THE DRAWINGS

The present invention is described in detail below with reference to the figures.

FIG. 1 shows a method for processing sensor data, a method for processing output data, and a signal processing unit, each in a particular example embodiment of the present invention.

FIGS. 2A-2C show a signal spectrum in a processing of sensor data using the method shown in FIG. 1.

### DETAILED DESCRIPTION OF EXAMPLE EMBODIMENTS

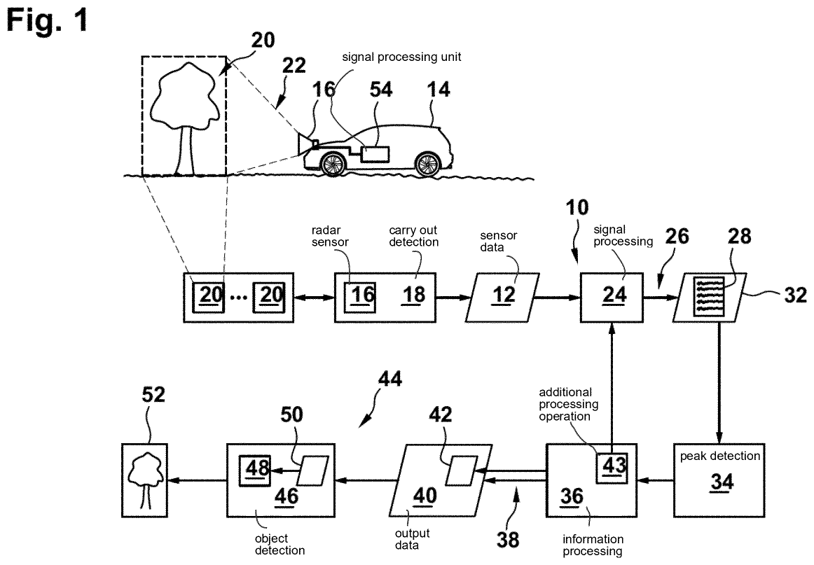

FIG. 1 shows a method for processing sensor data, a method for processing output data, and a signal processing unit, each in a particular embodiment of the present invention. The method 10 for processing sensor data 12 of a radar sensor 16 located in a vehicle 14 is preferably carried out when the vehicle 14 is operated. The operation 18 of the radar sensor 16 carries out a detection of object targets 20 in a surrounding area 22 of the vehicle 14.

First, a signal processing 24 of the sensor data 12 is carried out, followed by a providing 26 of processing data 32 obtained from the signal processing 24 and representable in at least one signal spectrum 28. The signal processing 24 may include noise suppression, signal filtering, and the like.

In the processing data 32, a peak detection 34 of at least one peak corresponding to one of the object targets 20 in the surrounding area 22 of a vehicle is carried out in the signal spectrum 28. After an information processing 36 of the processing data 32 assigned to the detected peak, an outputting 38 of output data 40 which are generated by the information processing 36 is then provided, which contain at least the peak position of the detected peak in the signal spectrum 28. The output data 40 have additional output data 42 which have at least one peak parameter of the peak in addition to the peak position. The additional output data 42 may be obtained by an additional processing operation 43. The additional processing operation 43 may be carried out with the information processing 36.

The signal processing 24 may in turn be carried out by feedback depending on the additional processing operation 43.

Further depicted is a method 44 for processing the output data 40 by carrying out object detection 46 of at least the one object target 20 in the surrounding area 22 of a vehicle using the output data 40 characterizing the object target 20 with the additional output data 42 as additional information. The object detection 46 comprises a machine learning process 48 with input data 50 formed by the output data 40 and the additional output data 42.

The object detection 46 may then output the detected object target 52. The output data processing may alternatively or additionally carry out an object classification.

The method 44 for processing the output data and/or the method 10 for processing sensor data may be carried out in a signal processing unit 54 in the vehicle 14. The signal processing unit 54 may be connected to the radar sensor 16 for data transmission.

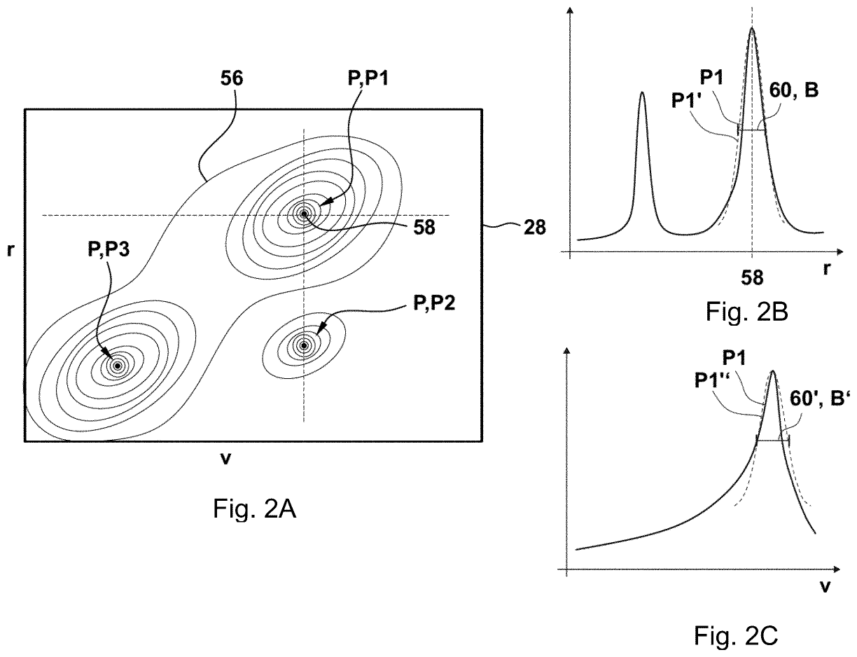

FIGS. 2A-2C show a signal spectrum in a processing of sensor data using the method shown in FIG. 1. FIG. 2A shows a two-dimensional representation of the three-dimensional signal spectrum 28, which specifies the signal intensity of the sensor signal as a function of the distance r in the direction of the ordinate and the velocity v in the direction of the abscissa.

The signal spectrum 28 may be a range Doppler diagram. The two-dimensional representation in FIG. 2A indicates the signal intensity as a function of the distance r and the velocity v via the contour lines 56.

A total of three peaks P are recognizable, a first peak P1 and a second peak P2, each corresponding to object targets moving at the same velocity v but at different distances r to the radar sensor, and a third peak P3 in the signal spectrum 28, which corresponds to an object target that is at a shorter distance r and a lower velocity v compared to the other two object targets.

FIG. 2B shows a section through the signal spectrum along the vertical section line shown in FIG. 2A. In the diagram, the signal intensity is plotted as a function of the distance r as the first dimension. The output data include, for example, the peak position 58 of the first peak P1 in the distance dimension.

In the information processing, the first peak P1 is assumed to be an idealized peak P′ corresponding to a predetermined shape, here as a first idealized peak P1′, which may be described by a Gaussian function, and a peak parameter 60, here a half-width B of the first idealized peak P1′ at least approximated to the first peak P1, is ascertained in the distance dimension. The peak parameter 60 may characterize the shape of the first idealized peak P1′ and thus approximately the shape of the first peak P1 in the distance dimension. The output data assigned to the first peak P1 thus comprise the peak position 58 and the peak parameter 60, here the half-width Br.

FIG. 2C depicts a section through the signal spectrum along the horizontal section line shown in FIG. 2A. In the diagram, the signal intensity is plotted as a function of the velocity v as the second dimension. In the information processing, a further peak parameter 60′, here a further half-width B′ of the further first idealized peak P1′′ in the velocity dimension, which at least approximates the first peak P1, is ascertained.

1-10. (canceled)

11. A method for processing sensor data of at least one radar sensor which detects object targets in a surrounding area of a vehicle, the method comprising the following steps
signal processing of the sensor data and providing processing data which are obtained by the signal processing and which are representable in at least one signal spectrum;
detecting at least one peak which corresponds to one of the object targets in the signal spectrum;
carrying out an information processing of the processing data assigned to the peak and outputting output data which are generated from the information processing and which contain at least a position of the detected peak in the signal spectrum;
wherein the output data have additional output data which include at least one peak parameter of the peak in addition to the peak position.

12. The method according to claim 11, wherein in the information processing, the peak is assumed to be an idealized peak corresponding to a predetermined shape and the additional output data include the peak parameter of the idealized peak at least approximated to the peak.

13. The method according to claim 11, wherein the peak parameter is a half-width of the peak.

14. The method according to claim 11, wherein the output data assigned to the peak exclusively include the peak position and the peak parameter.

15. The method according to claim 11, wherein the additional output data include, in addition to the peak parameter, a further peak parameter of the peak.

16. The method according to claim 11, wherein the signal spectrum is two-dimensional, and the peak parameter characterizes a shape of the peak in the signal spectrum.

17. The method according to claim 16, wherein the signal spectrum is three-dimensional and the peak parameter characterizes the shape of the peak in a first dimension of the signal spectrum, and the further peak parameter characterizes the shape of the peak in a second dimension of the signal spectrum.

18. The method according to claim 11, further comprising:
carrying out, using the output data characterizing the object target, an object detection and/or object classification of at least the one object target in the surrounding area of the vehicle, including using the additional output data as additional information.

19. The method according to claim 18, wherein the object detection and/or object the classification includes at least one machine learning process with input data formed by the output data including the additional output data.

20. A signal processer for a vehicle, the signal processor configured to process sensor data of at least one radar sensor which detects object targets in a surrounding area of the vehicle, the signal processor configured to:
signal process of the sensor data and providing processing data which are obtained by the signal processing and which are representable in at least one signal spectrum;
detect at least one peak which corresponds to one of the object targets in the signal spectrum;
carry out an information processing of the processing data assigned to the peak and outputting output data which are generated from the information processing and which contain at least a position of the detected peak in the signal spectrum;
wherein the output data have additional output data which include at least one peak parameter of the peak in addition to the peak position.
